(19) United States
(12) Patent Application Publication
(10) Pub. No.: US 2014/0338407 A1
(43) Pub. Date: Nov. 20, 2014

(54) Padlock with Resettable Password

(71) Applicant: Maotong ZHANG, Wenzhou City (CN)

(72) Inventor: Maotong ZHANG, Wenzhou City (CN)

(21) Appl. No.: 13/896,959

(22) Filed: May 17, 2013

(51) Int. Cl. E05B 37/00

(52) U.S. Cl. CPC E05B 37/0068
USPC 70/21

(57) ABSTRACT

A padlock whose password can be decoded and reset, consists of lock body, shackle and lock cup. In one side of the shackle resides the lock cup, a volute lock core and a blade. In the other side of the shackle resides letter wheels. All of these spare parts place together inside of the lock body and construct a completed product. The keyhole in the blades has a master key. The letters wheel links and works with the volute lock core by a moveable/loose piece, used for resetting the passwords. If the original password is garbled, the padlock will not unlock. In such a case, the master key will be used wherein the key is inserted into the volute lock core and rotated. That causes the moveable piece to move against the letter wheels and allows resetting of the password.

### BACKGROUND OF THE INVENTION

1. Field of the Invention

The present invention is directed to the field of security locks and, in particular to the field of combination locks using passwords that can be reset in the event a password is forgotten or requires changing.

2. Description of the Related Art

Currently there are different kind of locks, such as technique locks, digital locks and so on. Normally the immobilize key used in such locks has a plurality of unplug rings inside a lock housing. The unplug rings include a plurality of recesses. A gudgeon located in the center of the lock includes a plurality of bulge teeth which are used to lock the unplug rings. When the unplug rings move to the correct set password the lock can be placed from its locked state to its unlocked state.

However, this modern technique does not support unlocking if the passwords are garbled, forgotten, or otherwise need to be changed.

### SUMMARY OF THE INVENTION

To make up the shortage of the original lock technique, The improved padlock whose passwords can be decoded and reset is used with a master key, for allowing the password to be reset/changed.

In accordance with an embodiment, the disclosed padlock consists of a lock body, shackle and lock cup. One side of the shackle has the lock cup, a volute lock core and blades. Another side of the shackle includes a set of character or letter wheels containing letters and/or numbers or other symbols, are used to spell the password. All of these parts are placed together inside of the lock body to make up the completed padlock. A keyhole in the blades is configured to receive a master key. The letters wheel links with the volute lock core by a movable/loose piece for resetting the passwords. The general lashing set in the front part of the loose piece is placed inside of the groove of the loose piece, which is set beneath of the volute lock core. In the vertical of the gear gudgeon in the letter wheels is a gear centerline.

With the disclosed improved padlock, even if the original passwords are garbled, a user can unlock the lock with a master key. When the master key is inserted into the keyhole and revolved 180 degrees, the loose piece for resetting the passwords pushes forwards, and meets up with the gear centerline. When the centerline mark is visible, the password can be reset. Thereafter, the key is rotated back and removed to confirm the new password setting.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIGS. 1 and 2, respectively show the front and back of the inside construction of the padlock.

FIG. 3 shows the construction of the padlock with the lock body removed.

FIG. 4 shows the completed assembly of the lock.

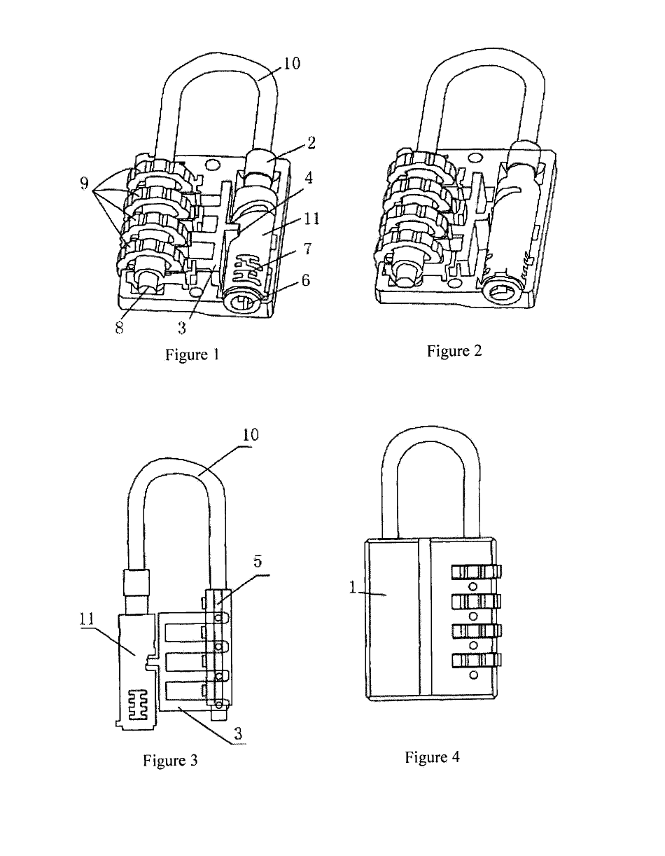

### DETAILED DESCRIPTION OF THE PRESENTLY PREFERRED EMBODIMENTS

The component parts of the padlock of the presently preferred embodiment are as follows: 1. lock body; 2. lock cup; 3. loose piece for resetting the passwords; 4. groove of loose piece; 5. gear centerline; 6. key; 7. blades; 8. snap ring; 9. letter wheels; 10. shackle; and 11. revolving lock core.

The padlock consists of lock body 1, shackle 10, and lock cup 2. In one side of the shackle there is a lock cup, a volute lock core 11 and blades 7. In the other side of the shackle there are some letter wheels 9, by general lashing 8. All of these components are placed together inside of the lock body and form a completed product. The blades 7 define a keyhole 6 for receiving a master key (not shown). The letter wheels link to and cooperate with the volute lock core by the loose piece 3. The loose piece is used for resetting a password that is used to open the shackle when the letters/characters of the letter wheels are turned/aligned to the password, as is known in the art.

The general lashing set in the front part of the moveable/loose piece is placed inside of the groove 4 of the loose piece, which is set beneath the volute lock core. In the vertical of gear gudgeon in the letters wheel sets a gear centerline 5. If the original password is garbled, i.e., the letter wheels are turned to the incorrect password, the key is inserted into the keyhole and revolved, such as at 180 degrees, to unlock the shackle. When the key is turned, the loose piece for resetting the password pushes forward and meets up with the gear centerline. When the centerline mark is visible, a user can reset the password by selecting a new one from the manipulation of the letter wheels. Thereafter, the key is again rotated and the new password will be stored and used for future unlocking of the lock.

It should be appreciated, that the use of the master key allows the password to be overridden and reset multiple times. In accordance with the present invention, a unique master key may be provided for each lock. However, in a preferred embodiment only a plurality of master key configurations will be available, and copies of the master keys will be paired to the specific locks.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A manually-operated padlock movable from a locked state to an unlocked state upon inputting a password, comprising:
a lock body;
a shackle;
a lock cup;
a volute lock core;
a plurality of character wheels;
a loose piece configured to contact the character wheels for resetting the password; and
a plurality of blades defining a keyhole therein for receiving an end of a master key, wherein a first side of the shackle contains the lock cup, the volute lock core and the blades; and wherein a second side of the shackle contains the plurality of character wheels, a portion of which extends from the lock body, and
wherein said character wheels link to and cooperate with the volute lock core by said loose piece such that said loose piece, upon inserting and turning of the master key in the keyhole, moves the character wheels to allow resetting of the password.

2. The padlock of claim 1, wherein a vertical of a gear gudgeon in the character wheels sets a gear centerline.

3. The padlock of claim 2, wherein, when the key is turned, the loose piece pushes forward and meets up with the gear centerline such that, when a centerline mark becomes visible, a user can reset the password by selecting a new password by manipulation of the character wheels.

4. The padlock of claim 1, wherein, after the password is reset, a further rotation of the key causes the new password to be stored and made available for subsequent unlocking of the lock.

5. The padlock of claim 1, wherein the padlock is configured such that use of the master key allows the password to be decoded and reset multiple times.

6. The padlock of claim 1, wherein said character wheels link to and cooperate with the volute lock core by said loose piece such that said loose piece, upon inserting and turning of the master key in the keyhole, moves the character wheels to allow decoding of the password.
